(19) United States
(12) Patent Application Publication
(10) Pub. No.: US 2015/0003724 A1
(43) Pub. Date: Jan. 1, 2015

(54) PICTURE PROCESSING APPARATUS, PICTURE PROCESSING METHOD, AND PICTURE PROCESSING PROGRAM

(71) Applicant: JVC KENWOOD Corporation, Yokohama-shi (JP)

(72) Inventor: Hiroshi Noguchi, Yokohama-shi (JP)

(21) Appl. No.: 14/304,639

(22) Filed: Jun. 13, 2014

(30) Foreign Application Priority Data
Jun. 28, 2013 (JP) 2013-135983

(51) Int. Cl. G06T 5/00; G06K 9/00

(52) U.S. Cl. CPC G06T 5/00; G06K 9/00677
USPC 382/154

(57) ABSTRACT

A depth map generator generates a depth map of an input picture. A depth map correction unit corrects the generated depth map. A picture generator shifts pixels of the input picture, based on the corrected depth map, so as to generate a picture having a different viewpoint. A level difference detector in the depth map correction unit detects a difference in depth values in a horizontal direction of the depth map, and a low-pass filter unit in the depth map correction unit applies a low-pass filter to part of the generated depth map, in response to the detected difference in the depth values.

### CROSS REFERENCE TO RELATED APPLICATION

This application is based upon and claims the benefit of priority from the prior Japanese Patent Application No. 2013-135983, filed Jun. 28, 2013, the contents of which are incorporated herein by references.

### BACKGROUND OF THE INVENTION

1. Field of the Invention

The present invention relates to a picture (or image) processing apparatus, a picture processing method and a picture processing program for converting a two-dimensional (2D) picture (or image) into a three-dimensional (3D) picture (or image) for the purpose of achieving a stereoscopic vision.

2. Description of the Related Art

In recent years, 3D video contents such as 3D movies and 3D broadcasting are in wide use. To allow a viewer or observer to have a stereoscopic view, a right-eye picture and a left-eye picture each having a parallax are required. When 3D video picture are displayed, a right-eye picture and a left-eye picture are displayed in a time-division manner. And the right-eye picture and the left-eye picture are separated from each other by use of video separating glasses such as shutter glasses or polarization glasses. This allows the viewer to have his/her right eye only see the right-eye pictures and have his/her left eye only see the left-eye pictures.

The production of 3D videos may be roughly classified into two methods. One is a method where a right-eye picture and a left-eye picture are simultaneously taken by two cameras. The other is a method where a 2D picture captured by a single camera is later edited so as to produce a parallax picture. The present invention relates to the latter method and relates to a technology for converting 2D pictures into 3D pictures.

FIG. 1 is a diagram for explaining a basic processing process for converting 2D pictures into 3D pictures (hereinafter abbreviated as “2D-to-3D conversion” or “2D/3D conversion” also). First, a depth map (hereinafter referred to as “depth information” also) is generated from a 2D input picture (Step S10). Then a 3D picture is generated using the 2D input picture and the depth map (Step S30). In FIG. 1, the 2D input picture is used as a right-eye picture for a 3D output picture, and a picture, where the 2D input picture has been pixel-shifted using the depth map, is used as a left-eye picture for the 3D output picture. A pair of a right-eye picture and a left-eye picture each having a predetermined parallax is called a 3D picture or a parallax picture.

When a 3D picture is produced as described above, pixels of a first 2D picture are shifted using the depth map and then a second 2D picture having a different viewpoint relative to the first 2D picture is generated (see Reference (1) in the following Related Art List). With this pixel shifting, there is generated one or more missing pixels within the thus generated second 2D picture having the different viewpoint.

FIG. 2 shows how the missing pixels occur as a result of the pixel shifting. When a picture, where a 2D input picture has been pixel-shifted using the depth map, is used as a left-eye picture for the 3D output picture, the following processing is carried out. That is, when a depth value indicates a pop-out direction in the production of a stereoscopic vision, pixels are shifted to the right; when the depth value indicates a depth direction, the pixels are shifted to the left. Directing the attentions to the figure of a person in FIG. 2, there is a large difference in depth values between the person and the road around the person. Since the person is in the foreground while the road is in the background, pixels of part corresponding to the person are shifted to the right. This pixel shifting creates a missing pixel region (see a portion indicated by “A1” in FIG. 2) on the left side of a boundary portion of the person.

### RELATED ART LIST

(1) Japanese Unexamined Patent Application Publication (Kokai) No. 2009-44722.

In general, the missing pixels caused by the pixel shifting are interpolated using peripheral pixels thereof. If the difference in depth values at an object boundary within a screen (this difference will be hereinafter referred to as “level difference of depth” also) is large, a pixel shift amount at the boundary portion will be large, too. Thus, the number of missing pixels, namely the area of the missing pixel region, will be large as well. As described above, those missing pixels are interpolated using the peripheral pixels thereof. However, as the area of the missing pixel region gets larger, the number of positions, where the dissociation or discrepancy between those pixels to be interpolated and the correct pixels is large, tends to increase.

### SUMMARY OF THE INVENTION

The present invention has been made in view of the foregoing circumstances, and a purpose thereof is to provide a technology by which the picture quality of boundary part of an object is enhanced when a 3D picture is generated from a 2D picture.

In order to resolve the above-described problems, a picture processing apparatus (100) according to one embodiment of the present invention includes: a depth map generator (10) configured to generate a depth map of an input picture; a depth map correction unit (20) configured to correct the depth map generated by the depth map generator; and a picture generator (30) configured to shift pixels of the input picture, based on the depth map corrected by the depth map correction unit, so as to generate a picture having a different viewpoint. The depth map correction unit (20) includes: a level difference detector (21) for detecting a difference in depth values of pixels in a horizontal direction of the depth map; and a low-pass filter unit (23) for applying a low-pass filter to part of the depth map generated by the depth map generator (10), in response to the detected difference in the depth values.

Another embodiment of the present invention relates to a picture processing method. The method includes: generating a depth map of an input picture; detecting a difference in depth values of pixels in a horizontal direction of the depth map; correcting the depth map by applying a low-pass filter to part of the depth map, in response to the detected difference of the depth values; and shifting pixels of the input picture, based on the corrected depth map, so as to generate a picture having a different viewpoint.

Optional combinations of the aforementioned constituting elements, and implementations of the invention in the form of methods, apparatuses, systems, recording media, computer programs and so forth may also be practiced as additional modes of the present invention.

### BRIEF DESCRIPTION OF THE DRAWINGS

Embodiments will now be described by way of examples only, with reference to the accompanying drawings, which are meant to be exemplary, not limiting and wherein like elements are numbered alike in several Figures in which:

FIG. 1 is a diagram for explaining a basic processing process for 2D/3D conversion;

FIG. 2 shows how missing pixels occur as a result of a pixel shifting.

FIG. 3 illustrates how pixels in a missing pixel region occurring on a left side of a boundary of a person shown in FIG. 2 are interpolated using a general pixel interpolating method;

FIG. 4 illustrates how pixels in a missing pixel region occurring on a left side of a boundary of a person shown in FIG. 2 are interpolated using a pixel interpolating method that uses a depth map to which a low-pass filter has been applied;

FIG. 5 shows a structure of a picture processing apparatus according to an embodiment of the present invention;

FIG. 6 shows a structure of a depth map generator according to an embodiment of the present invention;

FIG. 7 shows a structure of a depth map correction unit according to an embodiment of the present invention;

FIG. 8 is a graph showing conversion characteristics of a depth map edge level dpt_edge and a depth map edge level determining value dpt_jdg;

FIGS. 9A to 9C are diagrams for explaining a filter processing carried out when a foreground object is pixel-shifted to the right;

FIG. 10 illustrates how pixels in a missing pixel region occurring on a left side of a boundary of a person shown in FIG. 2 are interpolated using a pixel interpolating method according to an embodiment; and

FIGS. 11A to 11C are diagrams for explaining a filter processing carried out when a foreground object is pixel-shifted to the left.

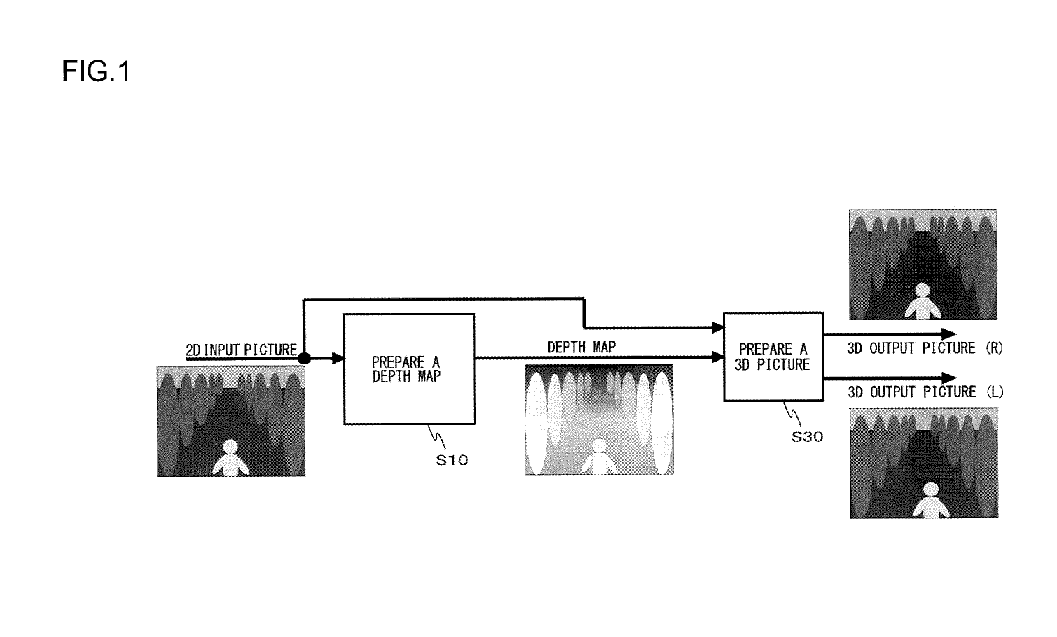

### DETAILED DESCRIPTION OF THE INVENTION

The invention will now be described by reference to the preferred embodiments. This does not intend to limit the scope of the present invention, but to exemplify the invention.

A general pixel interpolation method is given before a description of the embodiments.

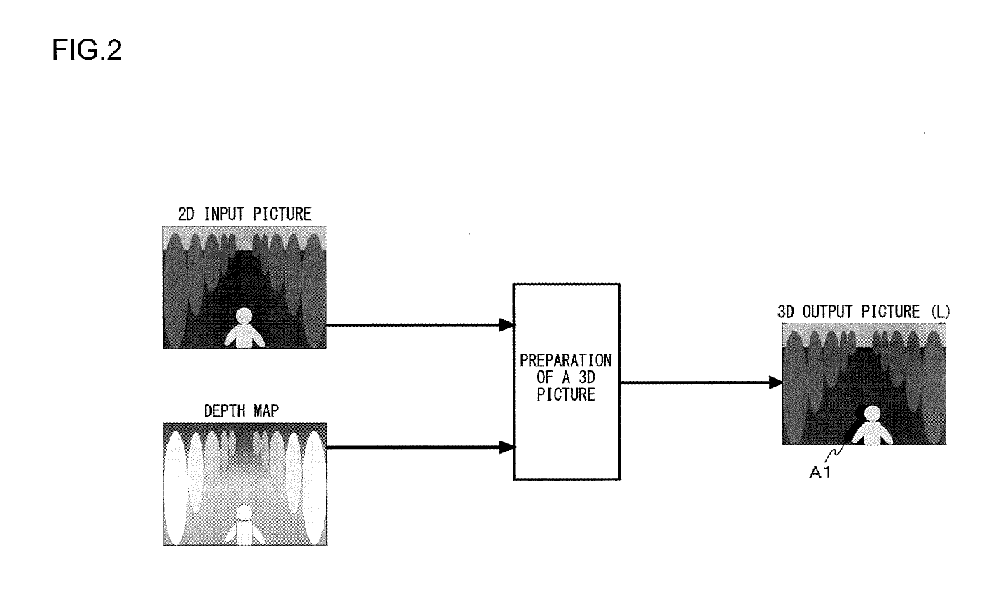

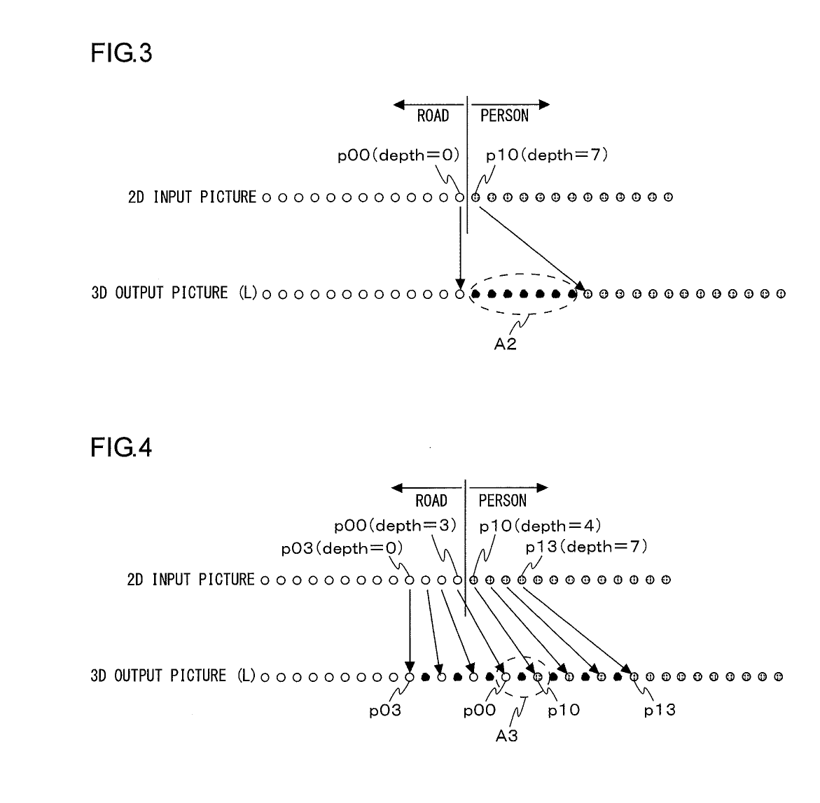

FIG. 3 illustrates how pixels in a missing pixel region occurring on a left side of a boundary of a person shown in FIG. 2 are interpolated using a general pixel interpolating method. Hereinafter, if the depth value is positive, it indicates a pop-out direction, whereas if negative, it indicates a depth direction. If the depth value of the person is 7 and the depth value of a road is 0, the only pixels of the human are shifted by 7 pixels to the right. Weighted average pixels of boundary pixels “p00” and “p10” are interpolated (see a portion encircled by a dotted line denoted by “A2” in FIG. 3) in the missing pixel region at a boundary portion between the road and the person. Using this method, the missing pixels are all filled in. At the same time, the larger the level difference of depth is, the larger the distance of the boundary pixels “p00” and “p10” will be. As a result, the image quality tends to drop if the level difference of depth is large.

As a method for avoiding the degradation of image quality, conceivable is a method where the depth map is subjected to a low-pass filter. As a low-pass filter is applied to the depth map, the level difference of depth at the boundary portion changes gradually and slowly. As a result, the interpolation quality is improved.

FIG. 4 illustrates how pixels in a missing pixel region occurring on the left side of the boundary of the person shown in FIG. 2 are interpolated using a pixel interpolating method that uses a depth map to which a low-pass filter has been applied. In FIG. 4, pixels “p00” to “p03” and “p10” to “p13” located near the boundary are pixel-shifted while the pitches between those pixels are gradually widened. Since the low-pass filter has been applied to the depth map, the depth values near the boundary vary in stages. Thus the shift amount of each of the pixels “p00” to “p03” and “p10” to “p13” differs pixel by pixel.

In FIG. 3, pixels “p00” to “p16” located near the boundary are pixel-shifted in the same way. Thus, a large dissociation or discrepancy occurs between two adjacent pixels (the pixel “p00” and the pixel “p10”) and the quality of interpolation pixels between the two adjacent pixels is basically low. In contrast to this, the missing pixel region in FIG. 4 occurs in a sparse manner rather than densely as lumps. Hence, the distance between both ends in each missing pixel region is relatively short and the interpolation pixels filled or embedded in the missing pixel region is of a high quality (see a portion encircled by a dotted line denoted by “A3” in FIG. 4).

Although a method where a low-pass filter is applied to a depth map is an effective way, the low-pass filter is applied to the entire region of the depth map and therefore a part of the depth map where no low-pass filter needs to be applied is also subjected thereto. For example, the low-pass filter is also applied to a on a right side of a boundary portion of the person shown in FIG. 2. When the pixels are to be shifted to the right, missing pixels occur on a left side of the boundary of an object. However, since the picture of the person, which is a picture in the foreground, is shifted to the right, no missing pixels occurs on the right side of the boundary of the object.

In a picture where the pixels have been shifted using a depth map to which the low-pass filter has been applied, the boundary of the object appears blurry. In a still picture and moving picture(s) to be 2D/3D converted, an object to be viewed by viewers is often located in the foreground. Thus, any blur at an edge of the object in the foreground is more likely to be conspicuous. It is therefore desirable that the low-pass filter be applied to an object boundary portion only, which is located on a side of the object where the missing pixels occur.

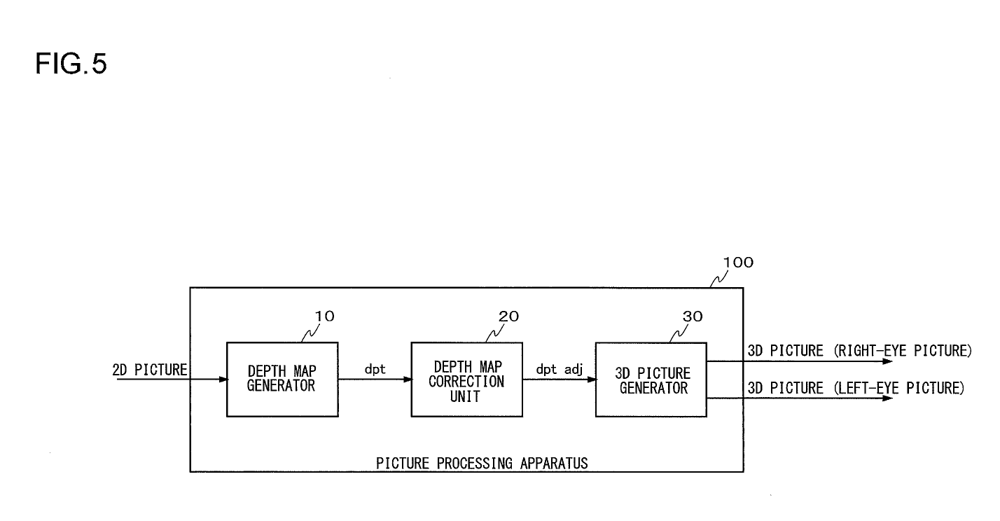

FIG. 5 shows a structure of a picture processing apparatus according to an embodiment of the present invention. A picture processing apparatus 100 according to the present embodiment includes a depth map generator 10, a depth map correction unit 20, and a 3D picture generator 30.

The depth map generator 10 analyzes a 2D picture, which is inputted to the depth map generator 10, and generates a pseudo-depth map. A description is hereunder given of specific examples of generating the depth map. Based on a 2D picture and a depth model that are inputted, the depth map generator 10 generates a depth map of this 2D picture. The depth map is a gray scale picture where a depth value is expressed by a luminance value. The depth map generator 10 estimates a scene structure and then generates a depth map using a depth model best suited to the scene structure. The depth map generator 10 combines a plurality of basic depth models and uses the thus combined one in the generation of the depth map. In so doing, the composition ratio of the plurality of basic depth models is varied according to the scene structure of this 2D picture.

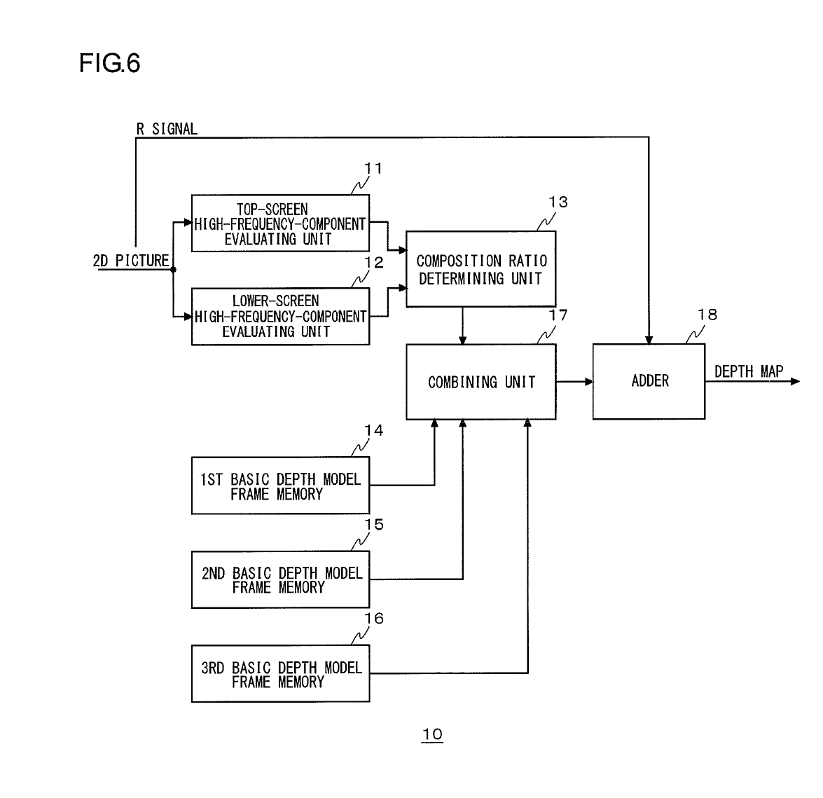

FIG. 6 shows a structure of the depth map generator 10 according to an embodiment of the present invention. The depth map generator 10 includes a top-screen high-frequency-component evaluating unit 11, a lower-screen high-frequency-component evaluating unit 12, a composition ratio determining unit 13, a first basic depth model frame memory 14, a second basic depth model frame memory 15, a third basic depth model frame memory 16, a combining unit 17, and an adder 18.

The top-screen high-frequency-component evaluating unit 11 calculates the ratio of pixels having high-frequency components at the top of a screen of a 2D picture to be processed. The calculated ratio thereof is set as a high-frequency-component evaluation value of a top part of the screen. The ratio of the top part of the screen to the entire screen is preferably set to about 20%. The lower-screen high-frequency-component evaluating unit 12 calculates the ratio of pixels having high-frequency components at a lower part of a screen of said 2D picture. The calculated ratio thereof is set as a high-frequency-component evaluation value of the lower part of the screen. The ratio of the lower part of the screen to the entire screen is preferably set to about 20%.

The first basic depth model frame memory 14 stores a first basic depth model. Similarly, the second basic depth model frame memory 15 stores a second basic depth model, and the third basic depth model frame memory 16 stores a third basic depth model. The first basic depth model is a model where the top part of the screen and the lower part of the screen are each a concave spherical surface. The second basic depth model is a model where the top part of the screen is a cylindrical surface having an axis line in a vertical direction and where the lower part of the screen is a concave spherical surface. The third basic depth model is a model where the top part of the screen is a planar surface and where the lower part of the screen is a cylindrical surface having an axis line in a horizontal direction.

The composition ratio determining unit 13 determines composition ratios k1, k2, and k3 of the first basic depth model, the second basic depth model, and the third basic depth model (where k1+k2+k3=1), respectively, based on the high-frequency-component evaluation values of the top part and the lower part of the screen calculated by the top-screen high-frequency-component evaluating unit 11 and the lower-screen high-frequency-component evaluating unit 12, respectively. The combining unit 17 multiplies the first basic depth model, the second basic depth model, and the third basic depth model by k1, k2, and k3, respectively, and then adds up the respective multiplication results. This calculation result is used as a combined basic depth model.

If, for example, the high-frequency-component evaluation value of the top part of the screen is small, the composition ratio determining unit 13 recognizes that there is a scene where the sky or flat wall is present in the top part of the screen. As a result, the ratio of the second basic depth model where the depth of the top part of the screen has been made larger is increased. If the high-frequency-component evaluation value of the lower part of the screen is small, the scene is recognized as one where a flat ground surface or water surface extending continuously in front is present in the lower part of the screen, and the ratio of the third basic depth model is increases. In the third basic depth mode, the top part of the screen is plane-approximated as the background; in the lower part of the screen, the depth is made smaller toward the bottom.

The adder 18 superimposes a red component (R) signal of the aforementioned 2D picture on the combined basic depth model generated by the combining unit 17 and thereby generates a depth map. The reason why the R signal is used herein is based on a rule of experience as follows. That is, in a condition where the environment is close to the direction light and the brightness of textures is not much different from each other, it is highly probable that the magnitude of R signal coincides with recess and projection of an object. Also, it is because red color and warm color are an advancing color in the chromatics, and the advancing color, such as red, is recognized more frontward than one based on a cold color and emphasizes the stereoscopic effect.

Now refer back to FIG. 5. The depth map correction unit 20 corrects the depth map generated by the depth map generator 10. A detailed description of the depth map correction unit 20 will be given later. The 3D picture generator 30 shifts a pixel or pixels of the aforementioned 2D picture, based on the depth map corrected by the depth map correction unit 20, so as to generate a 2D picture having a different viewpoint.

First, consider a case where a 2D picture having an original viewpoint is set to the right-eye picture and then a left-eye picture, where the viewpoint has been shifted to the left, is generated. In this case, when a texture is to be viewed stereoscopically in a pop-out direction relative to the viewer, the texture of the 2D picture having the original viewpoint is moved to the right of the screen according to the depth value. Conversely, when the texture is to be viewed stereoscopically in a depth direction relative to the viewer, the texture thereof is moved to the left of the screen according to the depth value.

Next, consider a case where the 2D picture having the original viewpoint is set to a left-eye picture and then a right-eye picture, where the viewpoint has been shifted to the right, is generated. In this case, when a texture is to be viewed stereoscopically in a pop-out direction relative to the viewer, the texture of the 2D picture having the original viewpoint is moved to the left of the screen according to the depth value. Conversely, when the texture is to be viewed stereoscopically in a depth direction relative to the viewer, the texture thereof is moved to the right of the screen according to the depth value.

The 3D picture generator 30 outputs the 2D picture having the original viewpoint and another 2D picture having a different viewpoint as a 3D picture. It is to be noted here that the detailed descriptions of generating the depth map by the depth map generator 10 and generating the 3D picture by the 3D picture generator 30 are disclosed in the aforementioned Reference (1) filed by the same applicant as that of the present patent specification.

Hereinafter, a depth map generated by the depth map generator 10 will be denoted by “depth map dpt”. Assume herein that each depth value constituting a depth map dpt takes a value ranging from −255 to 255. And assume also that when the depth value is positive, it indicates a pop-out direction, whereas when the depth value is negative, it indicates a depth direction. The setting is not limited to this and may be reversed instead, namely, when the depth value is negative, it may indicate a pop-out direction, whereas when the depth value is positive, it may indicate a depth direction.

The depth map correction unit 20 corrects the depth map dpt generated by the depth map generator 10 so as to generate a corrected depth map dpt_adj. The 3D picture generator 30 generates a 3D picture, based on the input 2D picture and the corrected depth map dpt_adj corrected by the depth map correction unit 20. In the present embodiment, the input 2D picture is directly outputted as a right-eye picture, and the picture generated by the pixel shifting is outputted as a left-eye picture.

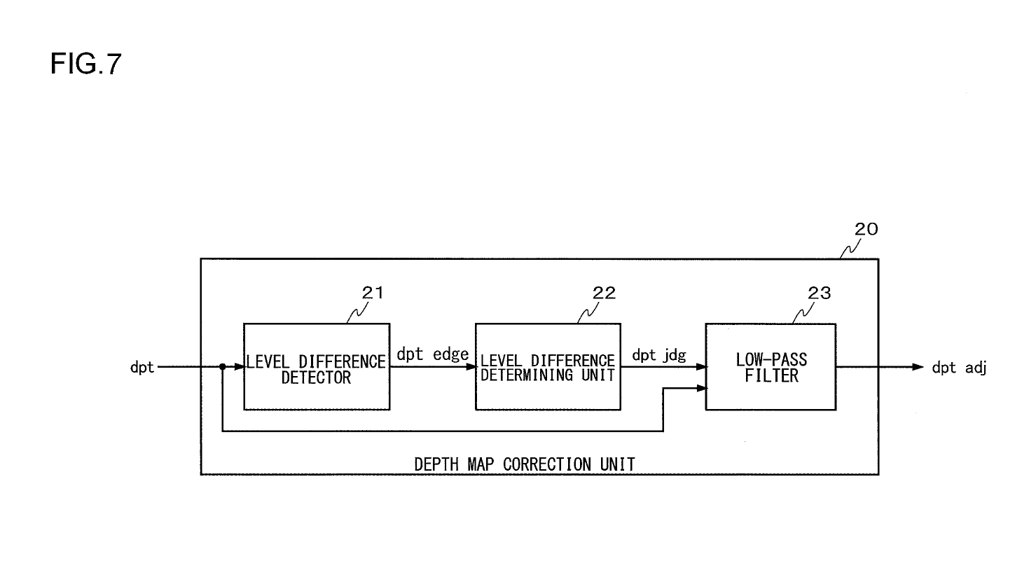

FIG. 7 shows a structure of the depth map correction unit 20 according to an embodiment of the present invention. The depth map correction unit 20 includes a level difference detector 21, a level difference determining unit 22, and a low-pass filter unit 23. The level difference detector 21 detects a level difference of the depth map in the horizontal direction. The level difference indicates an edge level in the horizontal direction.

The level difference detector 21 detects a level difference of the depth map dpt in the horizontal direction. For example, the level difference detector 21 detects a difference in depth values of pixels adjacent in the horizontal direction. To reduce the processing load, the difference in depth values may be detected at intervals of a predetermined number of pixels. The level difference determining unit 22 compares the difference in depth values, detected by the level difference detector 21, against a set threshold value and thereby detects an object boundary in the input 2D picture. The low-pass filter unit 23 applies a low-pass filter to part of the depth map dpt in response to the detected difference in the depth values. More specifically, the low-pass filter is applied to an object boundary portion on the side where missing pixels are caused by the pixel shifting.

The missing pixel region, caused by the pixel shifting, occurs on a left side of a boundary of a foreground object when the left-eye picture is generated by the pixel shifting. Similarly, the missing pixel region caused thereby occurs on a right side of the boundary of the foreground object when the right-eye picture is generated by the pixel shifting. The left side of the boundary of the foreground object is a rising edge where the detected level difference rises up to a positive value on a large scale. Similarly, the right side of the boundary of the foreground object is a falling edge where the detected level difference falls down to a negative value on a large scale. Conversely, the left side of a boundary of a background object is a falling edge where the detected level difference falls to a negative value on a large scale; the right side thereof is a rising edge where the detected level difference rises up to a positive value on a large scale.

When a left-eye picture is generated by the pixel shifting, the low-pass filter unit 23 applies a low-pass filter, as follows, with a boundary pixel position on the left side of the foreground object, namely a rising edge position where the level difference in the depth values rises up to a positive value on a large scale, as the reference point. That is, the low-pass filter unit 23 applies the low-pass filter to a region containing pixels starting at a rising edge position (starting position) up to a pixel position located apart by a preset number of pixels to the left of the starting position. In other words, the low-pass filter is applied to the region containing the pixels starting at the rising edge position up to a position of a predetermined pixel located leftward from the rising edge position. When a right-eye picture is generated by the pixel shifting, the low-pass filter is applied to a region containing pixels starting at a boundary pixel position on the right side of the foreground object, namely a falling edge position where the level difference in the depth values falls down to a negative value on a large scale, up to a pixel position located apart by a preset number of pixels to the right of the falling edge position. In other words, the low-pass filter is applied to the region containing the pixels starting at the falling edge position up to a position of a predetermined pixel rightward from the falling edge position.

If a left-eye picture is generated by the pixel shifting and if a foreground object and a background object or a background are related according to the following condition (1) or (2), a missing pixel or pixels occurs/occur.

(1) When the background object or the background is located on a left side of the foreground object, [the depth value of the foreground object]>0 and [the depth value of the foreground object]>[the depth value of the left-side background object.

(2) When the background object is located on a left side of the foreground object, [the depth value of the foreground object]<0 and [the depth value of the foreground object]>[the depth value of the left-side background object].

The condition (1) indicates a case where the foreground object is pixel-shifted to the right (in a pop-out direction) with the result that a missing pixel or pixels occurs/occur on a left side of the rising edge position.

The condition (2) indicates a case where the foreground object is pixel-shifted to the left (in a depth direction) and the background object is pixel-shifted to the left (in the depth direction) to a much greater degree as compared with the foreground object with the result that a missing pixel or pixels occurs/occur on a left side of the rising edge position.

If a right-eye picture is generated by the pixel shifting and if a foreground object and a background object or a background are related according to the following condition (3) or (4), a missing pixel or pixels occurs/occur.

(3) When the background object or the background is located on a right side of the foreground object, [the depth value of the foreground object]>0 and [the depth value of the foreground object]>[the depth value of the right-side background object.

(4) When the background object is located on a right side of the foreground object, [the depth value of the foreground object]<0 and [the depth value of the foreground object]>[the depth value of the right-side background object].

The condition (3) indicates a case where the foreground object is pixel-shifted to the left (in a pop-out direction) with the result that a missing pixel or pixels occurs/occur on a right side of the falling edge position.

The condition (4) indicates a case where the foreground object is pixel-shifted to the right (in a depth direction) and the background object is pixel-shifted to the right (in the depth direction) to a much greater degree as compared with the foreground object with the result that a missing pixel or pixels occurs/occur on a right side of the falling edge position.

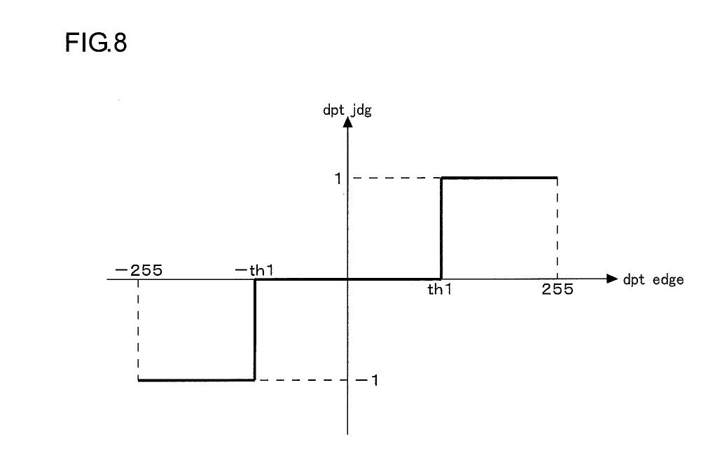

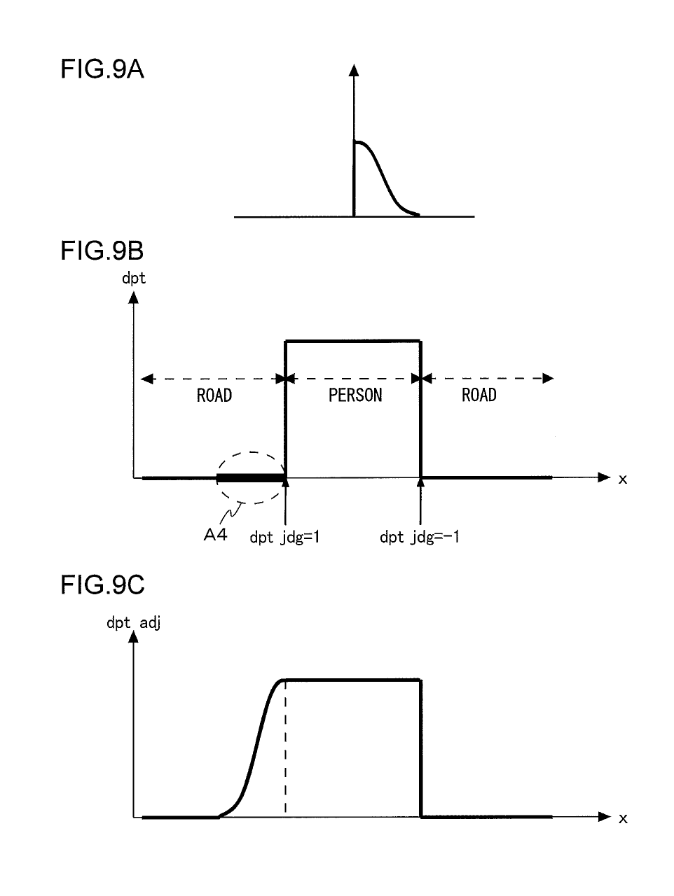

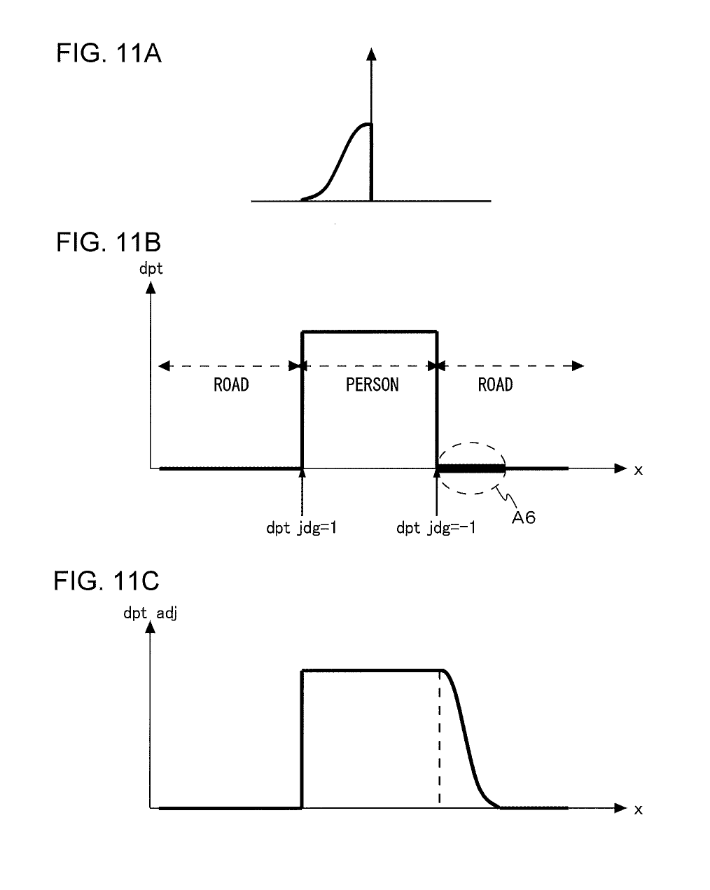

When the left-eye picture is to be generated by the pixel shifting, the filter characteristic of the low-pass filter unit 23 is set such that the low-pass filter has coefficients on the right side of the center and has no coefficients on the left side thereof (see FIG. 9A). When the right-eye picture is to be generated by the pixel shifting, the filter characteristic of the low-pass filter unit 23 is set such that it has coefficients on the left side of the center and has no coefficients on the right side thereof (see FIG. 11A).

A description is given hereunder using specific examples. The level difference detector 21 calculates a difference value of depth values between adjacent pixels, based on the following Equation (1), and then outputs its result as a depth map edge level dpt_edge. “dpt (x, y)” indicates a depth value wherein the horizontal position of an input picture is denoted by “x” and the vertical position thereof by “y”. Although, in the present embodiment, the result of calculating the difference between adjacent pixels is used to calculate the depth map edge level dpth_edge, this should not be considered as limiting. For example, the edge level may be calculated by applying a high-pass filter processing to the depth map.

dpt_edge (x, y)=dpt(x+1, y)−dpt(x, y) Equation (1)

The level difference determining unit 22 compares the depth map edge level dpt_edge against a threshold value th1 and then converts the depth map edge level dpt_edge into a depth map edge level determining value dpt_jdg that takes three values. The threshold value th1 is set to a value determined by a designer based on experiments, simulation runs, experimental rules or the like.

FIG. 8 is a graph showing conversion characteristics of the depth map edge level dpt_edge and the depth map edge level determining value dpt_jdg. The conversion characteristics are expressed by the following inequalities (2) to (4).

dpt_edge≧th1, dpt_jdg=1 Inequality (2)

th1>dpt_edge>th2, dpt_jdg=0 Inequality (3)

th2≧dpt_edge, dpt_jdg=−1 Inequality (4)

(th1>0, th2<0)

The pixel position where the depth map edge level determining value dpt_jdg=1 indicates a rising edge position of the depth map, while the pixel position where the depth map edge level determining value dpt_jdg=−1 indicates a falling edge position of the depth map. In the present embodiment, a region for which the depth map edge level determining value dpth_jdg=0 is provided such that a small and negligible level difference within the same object is not detected. This allows only a level difference between objects to be detected as an edge.

The low-pass filter unit 23 is comprised of a horizontal low-pass filter whose filter coefficient can be varied. While varying the filter coefficient based on the depth map edge level determining value dpt_jdg supplied from the level difference determining unit 22, the low-pass filter unit 23 applies a low-pass filter processing to the depth map dpt. More specifically, when a left-eye picture is to be generated by the pixel shifting, the low-pass filter changes its shape to one where the low-pass filter has coefficients on the right side only. And when a right-eye picture is to be generated by the pixel shifting, the low-pass filter changes its shape to one where the low-pass filter has coefficients on the left side only. In the horizontal low-pass filter, the number of taps used is 2N+1 (N being a natural number). A description is now given of specific exemplary operations.

FIGS. 9A to 9C are diagrams for explaining a filter processing carried out when a left-eye picture is generated by the pixel shifting. FIG. 9B schematically illustrates a depth map dpt of a region surrounding the person shown in FIG. 2. The depth value of the person is larger than that of the road around the person. In other words, the depth map dpt is such that the person is located more frontward than the road. For example, the depth value of the road is “0”, and that of the person is “7”. Since the person shown in FIG. 2 is a foreground object, the depth map edge level dpt_jdg is “1” on the left side of the boundary of the person and therefore the left side of the boundary thereof is a rising edge. On the right side of the boundary of the person, the depth map edge level dpt_jdg is “−1” and therefore the right side of the boundary thereof is a falling edge.

In the present embodiment, the left-eye picture is generated by the pixel shifting and therefore missing pixels occur, on a left side of the rising edge of the depth map dpt, in a pixel-shifted picture of the input 2D picture. The low-pass filter unit 23 applies the low-pass filter processing to the depth map dpt such that a low-pass filter is applied to only a region (see a portion encircled by a dotted line denoted by “A4” in FIG. 9B) starting from a horizontal position of the depth map dpt, for which the depth map edge level determining value dpt_jdg is “1”, up to a position located apart from the left side of the horizontal position by N pixels (N being a natural number).

The aforementioned “N” is set to a value determined by the designer based on experiments, simulation runs, experimental rules or the like. The aforementioned “N” may be a fixed or varying value. Where “N” is a varying value, it is varied proportionally to the level difference of boundary pixels detected by the level difference detector 21. In other words, the larger the level difference becomes, the larger the pixel shift amount will be; as a result, the low pass filter will be applied to a wider area.

FIG. 9A shows a filter characteristic of the low-pass filter unit 23 used for the depth map dpt of FIG. 9B. A filter with an asymmetrical frequency response as shown in FIG. 9A is used. FIG. 9C is an example of a corrected depth map dpt_adj on which the filter processing has been performed. The low-pass filter is applied to a region where the missing pixels occur, and the depth map dpt of a person region is such that an inputted signal is outputted as it is. The low-pass filter is not applied to the pixels, constituting the person region, which contain both end pixels of the person region and therefore an edge of the person does not get blurred or distorted in the pixel-shifted picture. On a left side of the boundary of the person region where the missing pixels occur in the pixel-shifted picture, pixels are shifted based on the depth map, to which the low-pass filter has been applied, before the pixels are interpolated. Thus, higher quality interpolation pixels can be generated.

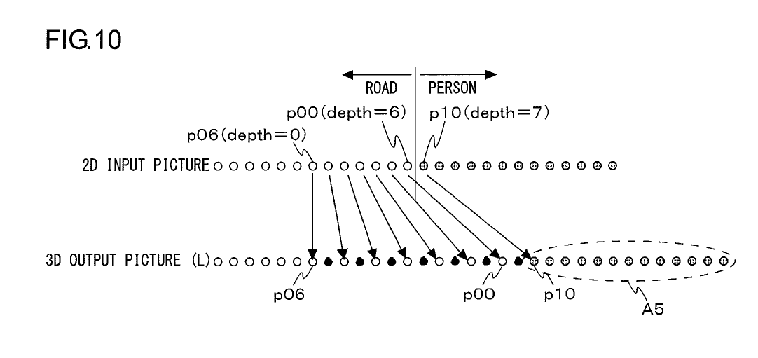

FIG. 10 illustrates how pixels in a missing pixel region occurring on the left side of the boundary of the person shown in FIG. 2 are interpolated using a pixel interpolating method according to an embodiment. Compared with FIG. 4, no low-pass filter is applied to the depth map dpt of the person region, and the low-pass filter is applied to only the depth map dpt of a road region on a left side of the boundary of the person region. Thus, the sparsity or interval widening of the person region, which has occurred in FIG. 4, does not occur in FIG. 10 (see a portion encircled by a dotted line denoted by “A5” in FIG. 10).

A description has been given of the case where the left-eye picture is generated by the pixel shifting, and a description is now given of the case where a right-eye picture is generated by the pixel shifting. FIGS. 11A to 11C are diagrams for explaining a filter processing carried out when a right-eye picture is generated by the pixel shifting. When a right-eye picture is to be generated by the pixel shifting, a missing pixel region occurs on a right side of a foreground object. In this case, the missing pixel region occurs on the right side of the falling edge of the depth map dpt shown in FIG. 11B. The low-pass filter unit 23 applies the low-pass filter processing to the depth map dpt such that a low -pass filter is applied to only a region (see a portion encircled by a dotted line denoted by “A6” in FIG. 11B) starting from a horizontal position of the depth map dpt, for which the depth map edge level determining value dpt_jdg is “−1”, up to a position located apart from the right side of the horizontal position by N pixels (N being a natural number).

FIG. 11A shows a filter characteristic of the low-pass filter unit 23 used for the depth map dpt of FIG. 11B. FIG. 11C is an example of a corrected depth map dpt_adj on which the filter processing has been performed. The low-pass filter is applied to a region where the missing pixels occur, and the depth map dpt of the person region is such that the inputted signal is outputted as it is.

It goes without saying that the picture processing as described above can be accomplished by transmitting, storing and receiving apparatuses using hardware. Also, the above-described picture processing can be accomplished by firmware stored in Read Only Memory (ROM), flash memory or the like, or realized by software such as a computer. A firmware program and a software program may be recorded in a recording medium readable by a computer or the like and then made available. Also, the firmware program and the software program may be made available from a server via a wired or wireless network. Further, the firmware program and the software program may be provided through the data broadcast by terrestrial or satellite digital broadcasting.

As described above, the present embodiments can prevent the deterioration of picture quality in the missing pixel region caused by the level difference of depth when a pixel-shifted picture is generated based on the depth map in the 2D-to-3D conversion. In other words, the rising edge position and the falling edge position of the depth map are identified by detecting the edge level of the depth map and determining the detected edge level. Then the low-pass filter processing using a low-pass filter with an asymmetrical frequency response is applied to only the peripheral regions of the rising edge position and the falling edge position. This allows the low-pass filter processing to be adaptively applied to only a region in a depth map where a missing pixel or missing pixels can occur in the generation of the pixel-shifted picture. Hence the quality of the pixel-shifted picture can be improved. Moreover, the low-pass filter processing is not applied to the unnecessary regions where no low-pass filter needs to be applied in the first place. Thus the sparsity and blurring of the object can be prevented. If the low-pass filter processing is accomplished by software, the amount of calculation can be reduced.

The present invention has been described based on the embodiments. The embodiments are intended to be illustrative only, and it is understood by those skilled in the art that various modifications to constituting elements or an arbitrary combination of each process could be further developed and that such modifications are also within the scope of the present invention.

For example, in the above-described embodiments, a description has been given of a case where one of a 3D picture is generated based on an input 2D image and its depth map and then the 2D picture is directly used as the other of the 3D picture. In this regard, both right-eye and left-eye pictures that constitute the 3D picture may be generated based on the input 2D picture and its depth map.

Assume that when the depth value is positive, the depth map dpt indicates a pop-out direction, whereas when it is negative, the depth map dpt indicates a depth direction. Then, for example, the pixels of the object in the input 2D picture are shifted by pixels of [dpt/2] to the right (left) based on the depth map dpt so as to generate a left-eye picture (right-eye picture); the pixels of the object in the input 2D picture are shifted by pixels of [−dpt/2] to the right (left) based on the depth map dpt so as to generate a right-eye picture (left-eye picture).

What is claimed is:

1. A picture processing apparatus comprising:
a depth map generator configured to generate a depth map of an input picture;
a depth map correction unit configured to correct the depth map generated by the depth map generator; and
a picture generator configured to shift pixels of the input picture, based on the depth map corrected by the depth map correction unit, so as to generate a picture having a different viewpoint,
the depth map correction unit including:
a level difference detector for detecting a difference in depth values of pixels in a horizontal direction of the depth map; and
a low-pass filter unit for applying a low-pass filter to part of the depth map generated by the depth map generator, in response to the detected difference in the depth values.

2. A picture processing apparatus according to claim 1 further comprising a level difference determining unit configured to compare the difference in depth values, detected by the level difference detector, against a threshold value and configured to detect an object boundary in the input picture,
wherein the low-pass filter unit applies the low-pass filter to the object boundary on a side, where a missing pixel or missing pixels occur as a result of shifting the pixels, in the depth map.

3. A picture processing apparatus according to claim 2, wherein the level difference determining unit detects a pixel position of a rising edge or a falling edge, based on the difference in the depth values,
wherein, when a left-eye picture having the different viewpoint is generated by the picture generator, the low-pass filter unit applies the low-pass filter to a region starting from a position of the rising edge up to a position of a predetermined pixel leftward from the rising edge, and
wherein, when a right-eye picture having the different viewpoint is generated by the picture generator, the low-pass filter unit applies the low-pass filter to a region starting from a position of the falling edge up to a position of a predetermined pixel rightward from the falling edge.

4. A picture processing apparatus according to claim 2, wherein, when a left-eye picture having the difference viewpoint is generated by the picture generator, a filter characteristic of the low-pass filter unit is set such that the low-pass filter has coefficients on a right side of a center and has no coefficients on a left side thereof, and
wherein, when a right-eye picture having the difference viewpoint is generated by the picture generator, a filter characteristic of the low-pass filter unit is set such that the low-pass filter has coefficients on the left side of the center and has no coefficients on the right side thereof.

5. A picture processing method comprising:
generating a depth map of an input picture;
detecting a difference in depth values of pixels in a horizontal direction of the depth map;
correcting the depth map by applying a low-pass filter to part of the depth map, in response to the detected difference in the depth values; and
shifting pixels of the input picture, based on the corrected depth map, so as to generate a picture having a different viewpoint.

6. A non-transitory computer-readable medium having embedded thereon a picture processing program,
the picture processing program comprising:
a depth map generating module operative to generate a depth map of an input picture;
a level difference detecting module operative to detect a difference in depth values in a horizontal direction of the depth map;
a depth map correction module operative to correct the depth map by applying a low-pass filter to part of the depth map, in response to the detected difference in the depth values; and
a picture generating module operative to shift pixels of the input picture, based on the corrected depth map, so as to generate a picture having a different viewpoint.
